(19) United States
(12) Patent Application Publication
(10) Pub. No.: US 2026/0250851 A1
(43) Pub. Date: Aug. 27, 2026

(54) WATER ELECTROLYSIS CATALYSIS PROMOTER AND WATER ELECTROLYSIS DEVICE USING THE SAME

(71) Applicant: KOREA INSTITUTE OF ENERGY RESEARCH, Daejeon (KR)

(72) Inventors: Sechan LEE, Cheongju-si (KR); Hyun Seok CHO, Sejong (KR); Min Joong KIM, Sejong (KR); Chang Soo LEE, Daejeon (KR)

(73) Assignee: KOREA INSTITUTE OF ENERGY RESEARCH, Daejeon (KR)

(21) Appl. No.: 18/726,031

(22) PCT Filed: Dec. 18, 2023
(86) PCT No.: PCT/KR2023/020871

§ 371 Date: Jul. 1, 2024

(30) Foreign Application Priority Data
Oct. 26, 2023 (KR) 10-2023-0144295

(51) Int. Cl. C25B 1/04; C25B 9/19; C25B 11/052; C25B 11/075

(52) U.S. Cl. CPC C25B 1/04; C25B 9/19; C25B 11/052; C25B 11/075

(57) ABSTRACT

The present invention relates to a catalysis promoter dissolved in an electrolyte of a water electrolysis device using an alkaline electrolyte and promoting the catalytic activity of an oxygen evolution electrode.

### TECHNICAL FIELD

The present invention relates to a water electrolysis catalysis promoter and a water electrolysis device using the same.

The water electrolysis catalysis promoter of the present invention may be added to an electrolyte of an alkaline water electrolysis device or an anion exchange membrane water electrolysis device.

### BACKGROUND ART

Now it seems that a hydrogen society is soon to be real.

Hydrogen society refers to a society, which is powered by hydrogen as a primary energy source and provides regions with universal access to hydrogen.

Entering the hydrogen society requires an established value chain of a stable hydrogen industry.

In particular, in order for the value chain of the hydrogen industry to work out, it is critical to match the production of hydrogen needed in the hydrogen society to demand.

Methods for producing hydrogen include a byproduct hydrogen method using hydrogen as a byproduct of other industries, a hydrogen extraction method reforming and decomposing fossil fuels or water to actively produce hydrogen, and a water electrolysis method electrolyzing water to produce hydrogen.

The byproduct hydrogen method causes CO₂ to be generated during the process of production, and also the byproduct hydrogen method alone is not capable of meeting a growing demand for hydrogen. The extraction hydrogen method also comes with a concern that CO₂ is generated during the process of hydrogen production. In order for hydrogen to be truly eco-friendly energy, there must be no CO₂ emissions during the production process, and a case in point in this regard is the water electrolysis method for producing hydrogen.

The water electrolysis method includes alkaline water electrolysis, polymer electrolyte membrane (PEM) water electrolysis, and solid oxide electrolyzer cell (SOEC) water electrolysis.

In particular, the alkaline water electrolysis is a technology that has been studied for a longest time and provides the highest technology readiness.

However, the method of producing hydrogen using an alkaline water electrolysis device still lacks economic feasibility and causes degradation in durability due to load fluctuations when producing hydrogen by supplying electric energy generated from eco-friendly energy such as wind power and solar power to the alkaline water electrolysis device.

Hydrogen production costs are too high to make the alkaline water electrolysis device for commercial use or large capacity, and thus economic feasibility has to be premised for establishing a value chain of a true hydrogen society.

The leading factor hindering the economic feasibility of the alkaline water electrolysis device currently is the use of precious metal-based electrode catalysts.

Precious metals cost high, and this is the primary cause behind the rising cost of the water electrolysis device, and there is also another concern that a large amount of CO₂ is generated in the process of producing precious metals as electrodes.

Accordingly, research is actively ongoing these days to use inexpensive 3d transition metals instead of precious metals as electrode catalysts.

However, the use of 3d transition metal as electrode catalysts brings about reduced performance and durability of water electrolysis compared to precious metal catalysts and requires additional processes.

In the end, both the precious metal catalysts and the 3d transition metal catalysts are hardly free from an issue of trade-off when used. Therefore, there is a need for a method capable of improving the performance of the alkaline water electrolysis device through different approaches.

### DISCLOSURE OF THE INVENTION

### Technical Problem

An aspect of the present invention provides a water electrolysis catalysis promoter capable of fundamentally promoting the activity of a catalyst, and a water electrolysis device having both improved economic feasibility and performance using the same.

Meanwhile, other aspects of the present invention unspecified in the specification will be additionally considered within a range that may be easily inferred from the detailed explanations described below and effects thereof.

### Technical Solution

To address the tasks described above, solutions below are provided.

A water electrolysis catalysis promoter according to an embodiment of the present invention is dissolved in an electrolyte of a water electrolysis device using an alkaline electrolyte and promotes the catalytic activity of an oxygen evolution electrode.

In an embodiment, the water electrolysis catalysis promoter may be oxidized in a dissolved state in an oxygen evolution reaction of the water electrolysis device and then evolution spontaneously reduced upon meeting an oxygen reaction intermediate product, thereby oxidizing the oxygen evolution reaction intermediate product.

In an embodiment, in the water electrolysis catalysis promoter, a redox potential in the alkaline electrolyte may be higher than an ideal redox potential for the oxygen evolution reaction and lower than an actual redox potential for the oxygen evolution reaction of a catalyst of the oxygen evolution electrode.

In an embodiment, the water electrolysis catalysis promoter may be a material having a nitroxyl group-based redox motif.

In an embodiment, in the water electrolysis catalytic activity promote, the substance having a nitroxyl group-based redox motif may be 2,2,6,6-tetramethylpiperidine-1-oxyl (TEMPO).

In an embodiment, in the water electrolysis catalytic activity promote, the substance having a nitroxyl group-based redox motif may be 4-hydroxy-2,2,6,6-tetramethylpiperidine-1-oxyl (HTEMPO).

In an embodiment, in the water electrolysis catalytic activity promote, the substance having a nitroxyl group-based redox motif may be 4-oxo-2,2,6,6-tetramethylpiperidine-1-oxyl (OTEMPO).

A water electrolysis device according to another embodiment of the present invention includes a catalysis promoter dissolved in an electrolyte and promoting the catalytic activity of an oxygen evolution electrode.

In another embodiment, the electrolyte may be KOH or NaOH.

In another embodiment, the water electrolysis device may be an alkaline water electrolysis device or an anion exchange membrane water electrolysis device.

In another embodiment, a catalyst of the oxygen evolution electrode may be at least any one selected from the group consisting of NiFe-LDH, electrodeposited Co, and electrodeposited Ni.

In another embodiment, the catalysis promoter may be oxidized in a dissolved state in an oxygen evolution reaction of the water electrolysis device and then spontaneously reduced upon an oxygen evolution reaction meeting intermediate product, thereby oxidizing the oxygen evolution reaction intermediate product.

In another embodiment, in the catalysis promoter, a redox potential in the alkaline electrolyte may be higher than an ideal potential for the oxygen evolution reaction and lower than an actual potential for the oxygen evolution reaction of a catalyst of the oxygen evolution electrode.

In another embodiment, the catalysis promoter may be at least any one selected from the group consisting of 2,6,6-tetramethylpiperidine-1-oxyl (TEMPO), 4-hydroxy-2,2,6,6-tetramethylpiperidine-1-oxyl (HTEMPO), and 4-oxo-2,2,6,6-tetramethylpiperidine-1-oxyl (OTEMPO).

In another embodiment, a catalyst of the oxygen evolution may be electrodeposited Ni, and the catalysis promoter may be 4-oxo-2,2,6,6-tetramethylpiperidine-1-oxyl (OTEMPO).

### Effects of the Invention

When a water electrolysis activity promoter according to an embodiment of the present invention is dissolved in an electrolyte of an alkaline water electrolysis device or an anion exchange membrane water electrolysis device, reduced activation energy and significantly reduced overvoltage are provided in oxygen evolution reaction (OER).

In addition, the water electrolysis activity promoter according to an embodiment of the present invention is still capable of promoting catalytic activity even after long-term operation.

Meanwhile, it should be noted that effects not mentioned explicitly herein but described in the following description expected by the technical characteristic of the present invention and potential effects thereof are considered as being described in the present invention.

### BRIEF DESCRIPTION OF THE DRAWINGS

FIG. 1 is a reference view for describing water electrolysis performance when using a precious metal-based catalyst and a 3d transition metal-based catalyst;

FIG. 2 is a reference view for describing the application of a catalysis promoter of the present invention to an alkaline water electrolysis device;

FIG. 3 is a reference view for describing a redox potential required for a catalysis promoter to promote catalytic activity for oxygen evolution reaction (OER);

FIG. 4 is a reference view for comparing and describing an OER process when a catalysis promoter is not dissolved in an electrolyte and a OER process when a catalysis promoter is dissolved in an electrolyte;

FIG. 5 shows chemical structural formulas of TEPMO, HTEMPO, and OTEMPO, which are usable as catalysis promoters for OER;

FIG. 6 is a reference view for describing mechanism of a redox reaction of TEMPO and derivatives thereof;

FIG. 7 is a graph showing CV curves upon dissolving 1 mM TEMPO in 1 M KOH electrolyte and then subjecting dissolved TEMPO molecules to a redox reaction through a three-electrode cell test;

FIG. 8 shows the results of comparing HOMO and LUMO energy levels of TEMPO, oxidized TEMPO, and water solvent molecules;

FIG. 9 shows the results of measuring FTIR spectrum of 1 M KOH electrolyte, TEMPO dissolved in 1 M KOH electrolyte, and raw TEMPO powder over time (15 minutes and 2 days later);

FIG. 10 is a reference view for describing a process of comparing and measuring OER overvoltage of an alkaline water electrolysis device depending on the presence or absence of a catalysis promoter to test the catalysis promoter on performance of promoting catalytic activity;

FIG. 11 shows LSV curves upon operation of an alkaline water electrolysis device depending on the presence or absence of a catalysis promoter;

FIG. 12 shows linear sweep voltammetry (LSV) curves of a NiFe-LDH catalyst in pristine 1 M KOH electrolyte and 1 M KOH containing 1 mM TEMPO according to reaction time at a constant voltage of 1.674 V vs. RHE;

FIG. 13 shows Tafel plots of a model OER catalyst of NiFe-LDH in pristine 1 M KOH electrolyte and 1 M KOH electrolyte containing 1 mM TEMPO;

FIG. 14 shows long-term durability of catalytic promotion ability of a catalysis promoter;

FIG. 15 shows the results of evaluating long-term durability of catalytic promotion ability of TEMPO for OER in alkaline water electrolysis under on/off operating conditions through LSV curves;

FIG. 16 shows i-V curves of an AEM-based single cell composed of a NiFe-LDH positive electrode and a Pt/C negative electrode measured at 50° C. by supplying each of pristine 1 M KOH electrolyte and 1 M KOH electrolyte containing 3 mM TEMPO (Solid lines and hollow circles each indicate data points of original i-V curves and HFR-corrected i-V curves);

FIG. 17 shows Nyquist plots of an AEM-based single cell composed of a NiFe-LDH positive electrode and a Pt/C negative electrode measured at 50° C. by supplying each of pristine 1 M KOH electrolyte and 1 M KOH electrolyte containing 3 mM TEMPO;

FIG. 18 shows an equivalent circuit model for EIS fitting;

FIG. 19 shows CV curves of a redox reaction obtained through a three-electrode cell test obtained by dissolving 1 mM of (a) HTEMPO and (b) OTEMPO in pristine 1 M KOH electrolyte;

FIG. 20 compares neutral and oxidized states of HTEMPO and OTEMPO, and HOMO and LUMO energy levels of water solvent molecules;

FIG. 21 shows the results of measuring FTIR spectrum of pristine (a) HTEMPO and (b) OTEMPO powder and (a) HTEMPO and (b) OTEMPO dissolved in 1 M KOH electrolyte over time (15 minutes and 2 days later);

FIG. 22 shows LSV curves for OER in pristine 1 M KOH electrolyte and 1 M KOH electrolyte containing 1 mM catalysis promoters (TEMPO, HTEMPO, and OTEMPO) along with an OER catalyst of NiFe-LDH;

FIG. 23 shows LSV curves of NiFe-LDH catalysts promoted by (a) TEMPO, (b) HTEMPO, and (c) OTEMPO according to exposure time under a fixed voltage condition of 1.674 V vs. RHE;

FIG. 24 shows LSV curves for OER in pristine 1 M KOH electrolyte and 1 M KOH electrolyte containing 1 mM catalysis promoters (TEMPO, HTEMPO, and OTEMPO) along with an OER catalyst of electrodeposited Co;

FIG. 25 shows LSV curves for OER in pristine 1 M KOH electrolyte and 1 M KOH electrolyte containing 1 mM catalysis promoters (TEMPO, HTEMPO, and OTEMPO) along with an OER catalyst of electrodeposited Ni;

FIG. 26 shows LSV curves of electrodeposited Co catalysts promoted by (a) TEMPO, (b) HTEMPO, and (c) OTEMPO according to exposure time under a fixed voltage condition of 1.674 V vs. RHE;

FIG. 27 shows LSV curves of electrodeposited Ni catalysts promoted by (a) TEMPO, (b) HTEMPO, and (c) OTEMPO according to exposure time under a fixed voltage condition of 1.674 V vs. RHE;

FIG. 28A compares molecular orbital energy levels of TEMPO, HTEMPO, and OTEMPO in neutral and oxidized states of water, and FIG. 28B is an enlarged view emphasizing the HOMO level of TEMPO series in the neutral state; In this case, the gray dotted line indicates theoretical OER formation energy (4OH—→O2+2H2O+4e) corresponding to ideal OER potential (−4.844 eV vs. vacuum and 1.23 V vs RHE), and the blue dotted line indicates actual OER potential of NiFe-LDH, an OER catalyst (−5.134 eV vs. vacuum and 1.52 V vs. RHE);

FIG. 29 shows the result of measuring the ratio of ring current to disk current of the model NiFe-LDH catalyst in pristine 1 M KOH electrolyte and 1 M KOH electrolyte containing 1 mM catalysis promoters (TEMPO, HTEMPO, and OTEMPO) in RRDE analysis;

FIG. 30 shows the result of measuring ring current and disk current of the model NiFe-LDH catalyst over time in pristine 1 M KOH electrolyte and 1 M KOH electrolyte containing 1 mM catalysis promoters (TEMPO, HTEMPO, and OTEMPO) in RRDE analysis; and

FIG. 31 is a measurement of chemical stability of TEMPO, HTEMPO, and OTEMPO under OER conditions, and shows the results of measuring UV-Vis spectrum of (a)₁ M KOH and TEMPO series dissolved in 1 M KOH, and ex-situ UV-Vis spectrum of 1 M KOH containing a catalysis promoter before promoting, after promoting, and upon long-term storage after promoting for (b) TEMPO, (c) HTEMPO, and (d) OTEMPO.

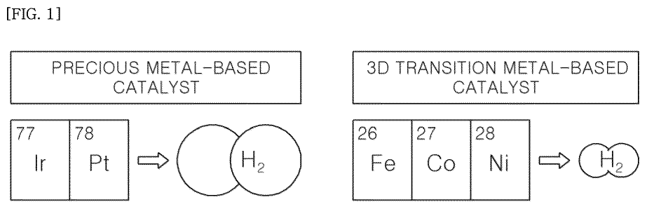

The accompanying drawings are presented to aid in understanding the technical idea of the present invention, and thus, the scope of protective rights of the present invention shall not construed as being limited thereto.

### MODE FOR CARRYING OUT THE INVENTION

Hereinafter, components of the present invention guided by various embodiments of the present invention and effects therefrom will be described with reference to the drawings.

Also, in describing the present invention, detailed descriptions of related known functions will be omitted when it is determined that the detailed descriptions may unnecessarily obscure the gist of the present invention.

Alkaline water electrolysis is a commercialized technology configured to electrolyze water using an alkaline electrolyte.

A process of the alkaline water electrolysis is as follows.

At a cathode, alkaline solutions such as KOH and NaOH are reduced to hydrogen (H₂) and hydroxyl ions (OH—) are generated.

The generated hydrogen is recombined in gaseous form on a cathode surface, and the hydroxyl ions (OH—) move to an anode through a porous septum due to a potential difference between the anode and the cathode.

At the anode, the hydroxyl ions (OH) are oxidized to produce water (H₂O) and oxygen (O₂).

Precious metal-based catalysts are used to increase hydrogen production efficiency in water electrolysis devices.

However, due to issues such as high-priced precious metal-based catalysts and CO₂ generated upon producing precious metal-based catalysts, research is actively ongoing to use eco-friendly 3d transition metal-based catalysts.

However, the 3d transition metal-based catalysts developed so far have limitations in that performance thereof is limited compared to precious metal-based catalysts.

The present invention is the first to introduce an electrolyte-added cocatalyst as a component that was not introduced in typical water electrolysis devices, and improves water electrolysis performance by dissolving a catalysis promoter in an electrolyte.

In order for a water electrolysis reaction to take place in a water electrolysis device, at the anode, a potential higher than an ideal oxygen evolution reaction (OER) potential of 1.229 V vs. RHE needs to be applied.

An actual OER potential is affected by the type of catalyst used.

When a 3d transition metal-based catalyst is used as an anode catalyst, the equipment cost of a water electrolysis device may be reduced, but the required OER potential is higher than that of a precious metal catalyst, and accordingly, the cost required for hydrogen production increases.

That is, a trade-off between replacing precious metal-based catalysts with relatively inexpensive and eco-friendly 3d transition metal-based catalysts and efficient hydrogen production using high-performance precious metal-based catalysts takes place.

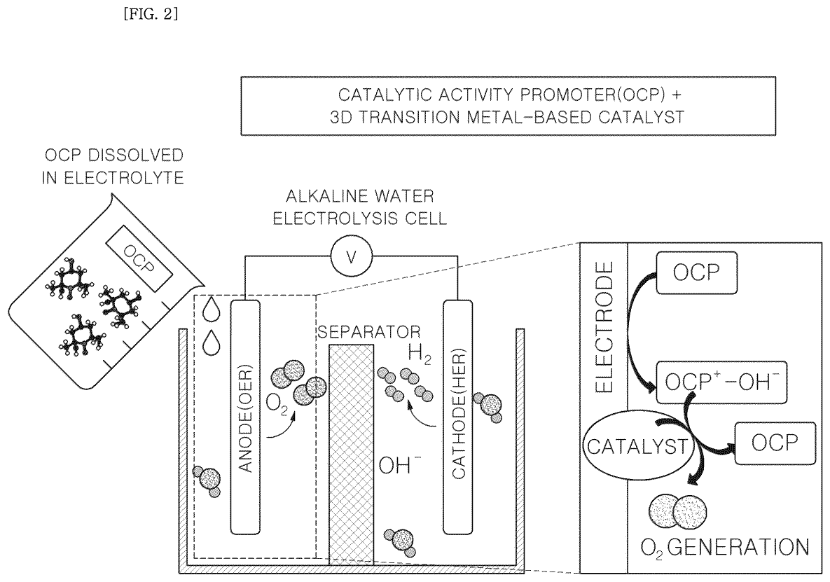

When the catalysis promoter of the present invention is used, water electrolysis efficiency may be increased. Therefore, when the catalysis promoter of the present invention is applied to a 3d transition metal-based catalyst as shown in FIG. 2, high hydrogen production efficiency may be achieved along with benefits such as the low cost and environmental friendliness of 3d transition metal-based catalysts.

The catalysis promoter to be used on an OER electrode may satisfy three conditions to be used.

First, the catalysis promoter needs to be dissolved in a basic electrolyte and needs to remain stable.

Second, a redox potential of the catalysis promoter needs to be higher than a theoretical OER potential.

Third, a redox potential of the catalysis promoter needs to be lower than an actual OER potential.

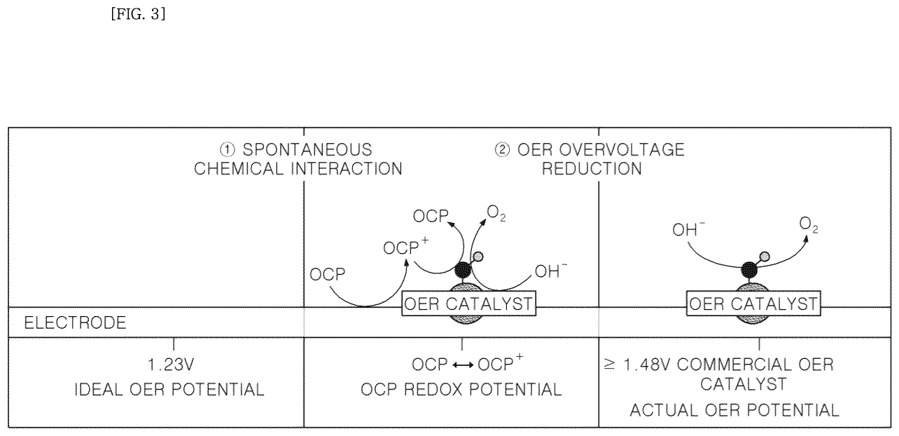

As shown in FIG. 3, the second condition needs to be satisfied to induce a continuous spontaneous promotion reaction of the catalysis promoter, and the third condition needs to be satisfied to achieve an overvoltage that is lower than an overvoltage shown by the actual OER catalyst, thereby improving the performance of the water electrolysis device.

How the water electrolysis catalysis promoter of the present invention works in OER is compared with a typical OER reaction as follows.

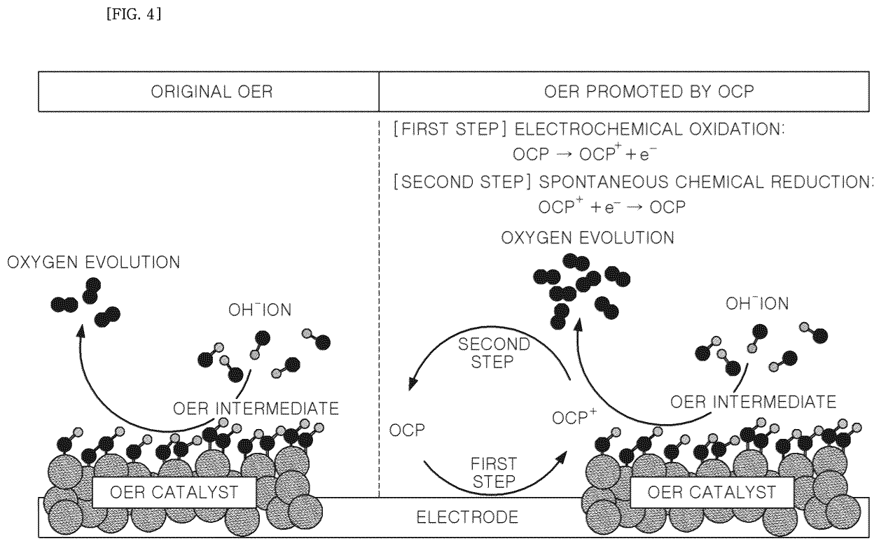

When the catalysis promoter of the present invention is not dissolved in an electrolyte, as shown on the left side of FIG. 4, an OER intermediate product meets OH-ions in the electrolyte and is oxidized to generate oxygen and water.

However, when the catalysis promoter of the present invention is dissolved in an electrolyte, upon the OER, as shown on the right side of FIG. 4, the OER is promoted over two stages.

When voltage is applied to the anode, the catalysis promoter dissolved in an electrolyte meets an anode surface and causes an electrochemical oxidation reaction.

Thereafter, the oxidized catalysis promoter has a redox potential lower than the actual OER potential and has a redox potential higher than the theoretical OER potential, and thus undergoes a spontaneous chemical reaction with the OER intermediate product on the anode surface and is reduced to generate oxygen.

Through this process, activation energy of the OER is reduced, overvoltage is significantly reduced, and long-term durability of the anode is increased as well.

In addition, the catalysis promoter of the present invention enables continuous promotion of OER reaction by repeating electrochemical oxidation and reduction though spontaneous chemical reactions while the OER takes place.

When the OER, which is generally known to be slower than HER, is promoted, the water electrolysis device has improved overall performance.

That is, even when a 3d transition metal-based catalyst is used as an OER electrode, performance may be improved to the level given from a precious metal-based catalyst, reducing the cost of water electrolysis device, and a greater amount of hydrogen may be produced using less current than before, thereby improving economic feasibility.

As the catalysis promoter of the present invention used in the OER, a compound having a nitroxyl group-based redox motif may be used.

For example, a 2,2,6,6-tetramethylpiperidine-1-oxyl (TEMPO) based additive may be used.

More specifically, at least any one selected from the group consisting of TEMPO, OTEMPO, and HTEMPO may be used as the catalysis promoter.

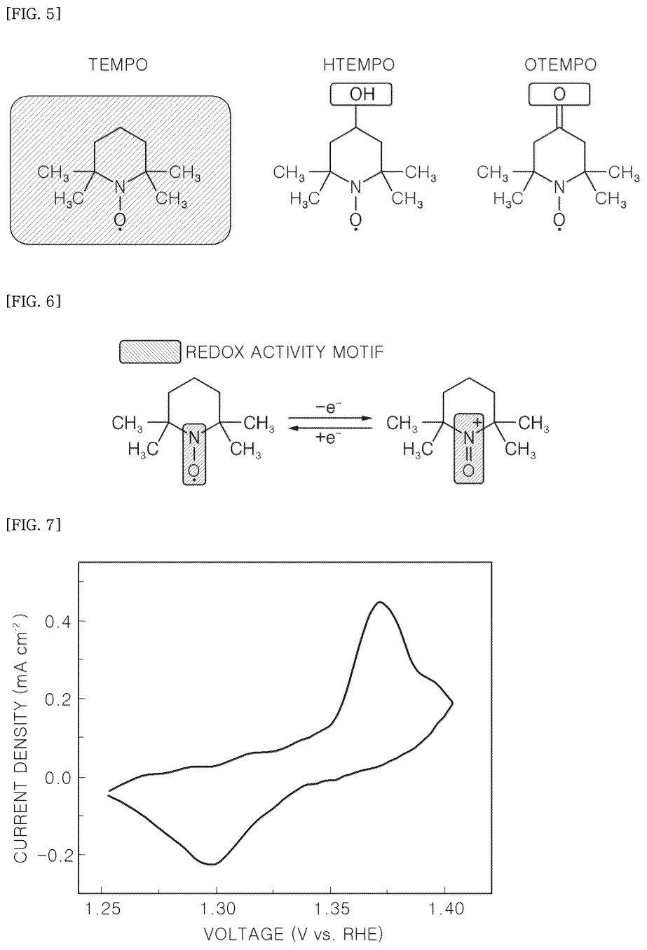

In this case, OTEMPO is a TEMPO derivative in which an oxo group (═O) is additionally bonded to TEMPO, and HTEMPO is a TEMPO derivative in which a hydroxyl group (—OH) additionally bonded to TEMPO (see FIG. 5).

As shown in FIG. 6, TEMPO and derivatives thereof have a redox-active motif in which electrons are lost and gained by a nitroxyl group working as a redox center during a redox reaction.

In addition, it t is determined that TEMPO and derivatives thereof are well dissolved in strong basic electrolytes used as electrolytes in water electrolysis devices and thus redox reactions take place.

In particular, a redox potential of TEMPO measured in 1 M KOH through CV curves in FIG. 7 is about 1.335 V vs. RHE.

This is higher than the ideal redox potential of OER, 1.229 V, and lower than the redox potential of generally known catalysts, which is 1.48 V.

In addition, chemical of stability TEMPO and derivatives thereof in alkaline-based water electrolysis devices (e.g., alkaline water electrolysis devices or anion exchange membrane water electrolysis devices, and the like) is determined through lowest unoccupied molecular orbital (LUMO) and highest occupied molecular orbital (HOMO) energy level calculations and Fourier transform infrared (FTIR) spectroscopy.

Spontaneity of chemical reactions between TEMPO and electrolytes may be determined by comparing the molecular orbital energy levels of neutral and charged states of TEMPO molecule with the molecular orbital energy levels of water solvent molecules.

The energy levels of TEMPO and water solvent molecules were calculated using the dielectric constant (c) of water.

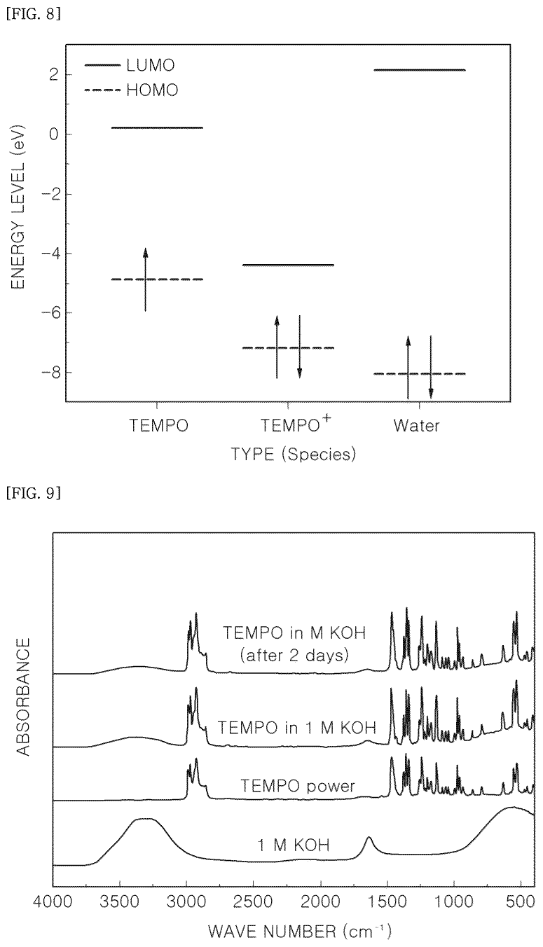

As shown in FIG. 8, the HOMO energy levels of TEMPO and oxidized TEMPO are −4.90 eV and −7.16 eV, respectively, which are positioned below the LUMO energy level of water molecules (2.13 eV).

This indicates that extraction of electrons through oxidization of TEMPO and oxidized TEMPO is not achievable using water solvents.

In addition, the HOMO energy level of water molecules (−8.05 eV) is positioned below the LUMO energy levels of TEMPO and oxidized TEMPO, corresponding to 0.19 eV and −4.42 eV, respectively.

Therefore, TEMPO may serve as a catalysis promoter in an aqueous electrolyte without side reactions.

In addition, like TEMPO, derivatives of TEMPO may serve as catalysis promoters in aqueous electrolytes without side reactions.

Meanwhile, as shown in FIG. 9, fingerprint peaks for chemical bonding environment of TEMPO are well maintained even after dissolution in an electrolyte of 1 M KOH aqueous solution, indicating that TEMPO is chemically stable in alkaline aqueous solution environment.

Therefore, when TEMPO and derivatives thereof are used as a water electrolysis activity promoter, an effect of catalytic promotion is achieved and also the effect may be maintained for the long term.

In conclusion, TEMPO and derivatives thereof satisfy the three requirements for use as a catalysis promoter described above, and the benefit is that TEMPO and derivatives thereof are stable even in alkaline environment.

In addition, materials that satisfy the three requirements for use as a catalysis promoter described above may be used as a catalysis promoter.

Hereinafter, various experiments performed to determine the performance of the catalysis promoter of the present invention will be described.

First, TEMPO was dissolved in an electrolyte as a catalysis promoter to promote the performance of NiFe layered double hydroxide (NiFe-LDH) catalyst, known as a high-performance OER catalyst for alkaline water electrolysis devices.

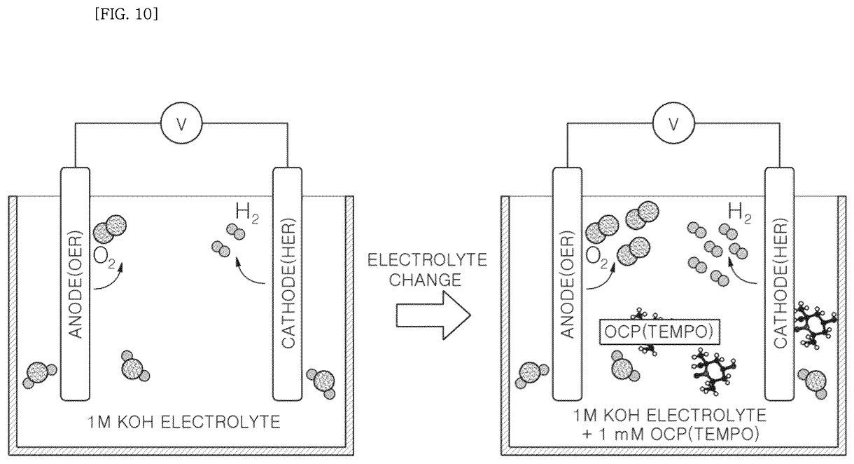

As shown in FIG. 10, OER overpotential was first measured using a model OER catalyst in pristine 1 M KOH electrolyte, and then the electrolyte was changed to 1 M KOH aqueous solution in which 1 mM catalysis promoter (TEMPO) was dissolved to measure the OER overpotential.

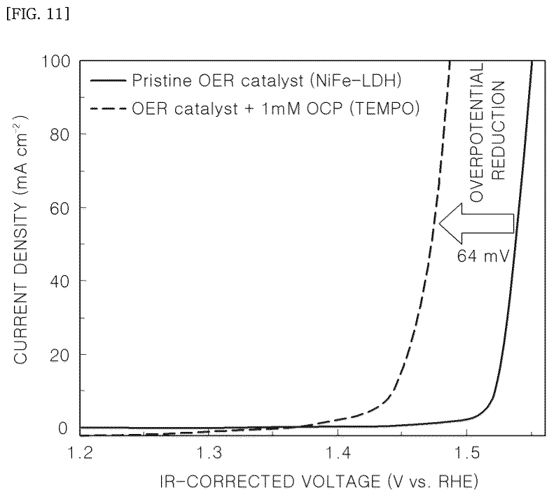

The results of measuring the overvoltage are shown in FIG. 11.

NiFe-LDH in pristine electrolyte showed an OER overpotential of 320 mV at a current density of 100 mA/cm².

In contrast, the TEMPO-added electrolyte showed a significantly reduced OER overpotential of 256 mV at a current density of 100 mA/cm².

That is, it is seen that in alkaline water electrolysis, catalytic promotion ability is improved by applying only a very small amount of 1 mM TEMPO to an electrolyte.

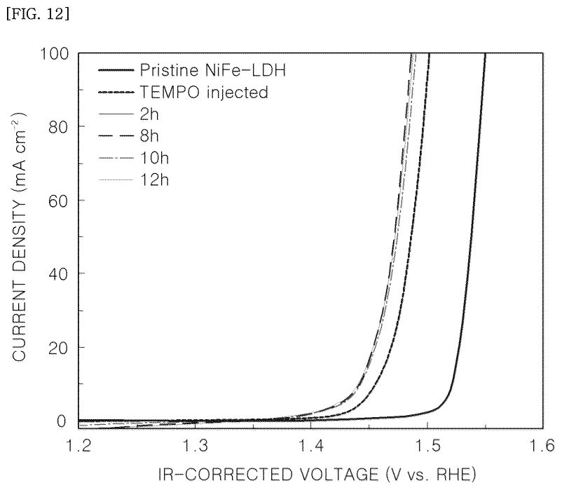

Meanwhile, as shown in FIG. 12, as soon as the TEMPO-containing electrolyte is applied, the overvoltage is reduced to 270 mV at a current density of 100 mA/cm², indicating that an effect of catalytic promotion takes place immediately.

Then, the effect of the catalysis promoter increased for up to 2 hours and the overvoltage decreased to 256 mV at a current density of 100 mA/cm².

Since there is almost no increase or decrease in overvoltage after 2 hours, it is determined that the effect of catalytic promotion is maximized after operation for about 2 hours.

This change in the effect of catalytic promotion is assumed to be due to the mass transport of TEMPO.

Specifically, TEMPO dissolved around an electrode is oxidized first, and the oxidized TEMPO diffuses due to concentration gradient.

This series of cyclic movements in the neutral and oxidized states of TEMPO are optimized for a certain period of time, and the process influences the critical time for catalytic promotion.

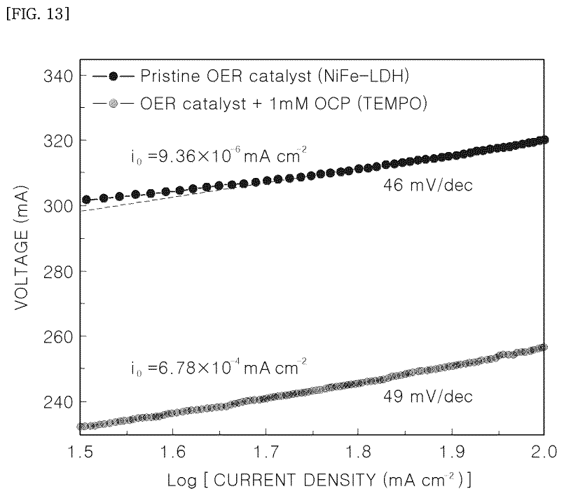

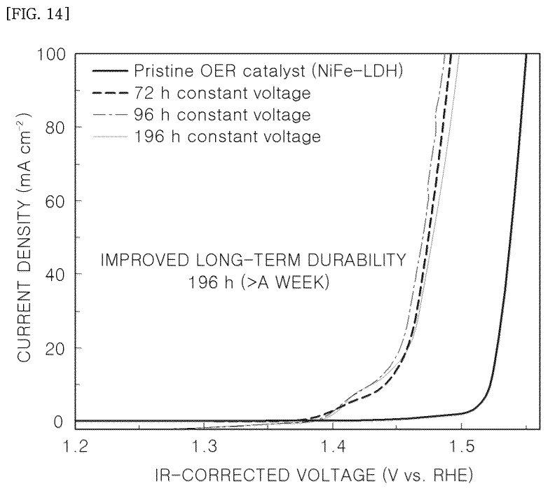

Improvement in kinetic characteristics of the OER catalyst due to catalytic promotion and the long-term durability of promotion ability of the catalytic promotion activator were evaluated and are shown in FIGS. 13 and 14, respectively.

Exchange current density is a kinetic parameter directly related to activation energy of a governing reaction, i.e., in this case OER, as described in Equations 1 to 3 below.

$${i}_{0} ∝ {nFk}_{0} \qquad ( 1 )$$

$${k}_{0} = {Ae}^{- \frac{{E}_{A}}{RT}} \qquad ( 2 )$$

$${i}_{0} ∝ {e}^{- {E}_{A}} \qquad ( 3 )$$

Herein, i₀: exchange current density, n: number of electrons, F: Faraday constant, k₀: standard rate constant, A: pre-exponential factor, E_{A}: activation energy of reaction, R: gas constant, T: absolute temperature.

An increase in exchange current density implies a decrease in the activation energy of OER according to Equation 3.

However, as shown in FIG. 13, when comparing the exchange current density of NiFe-LDH in the pristine electrolyte and the TEMPO-containing electrolyte, it is seen that there is a significant difference.

The significant difference is shown between the exchange current density of NiFe-LDH in the pristine electrolyte, which is 9.36×10⁻⁶ mA/cm², and the exchange current density of NiFe-LDH in the electrolyte and TEMPO-containing electrolyte, which is 6.78×10⁻⁴ mA/cm².

The exchange current density of NiFe-LDH in the TEMPO-containing electrolyte increased by approximately 102 times compared to that of NiFe-LDH in the pristine electrolyte, indicating a significant decrease in the activation energy.

Meanwhile, Tafel slopes of NiFe-LDH working in the pristine electrolyte and the TEMPO-containing electrolyte are 46 mV/dec and 49 mV/dec, which are similar values.

When a catalysis promoter was applied, a slightly higher Tafel slope was observed, which appears to be due to OER mechanism changed by the addition of the catalysis promoter.

The catalysis promoter has excellent long-term durability for catalytic activity ability.

As shown in FIG. 14, the reduced OER overpotential of NiFe-LDH resulting from catalytic promotion, showing 256 mV at a current density of 100 mA/cm², is well maintained in the range of 250 to 260 mV at a current density of 100 mA/cm² for 196 hours (a week or greater) at a constant voltage of 1.674 V VS. RHE.

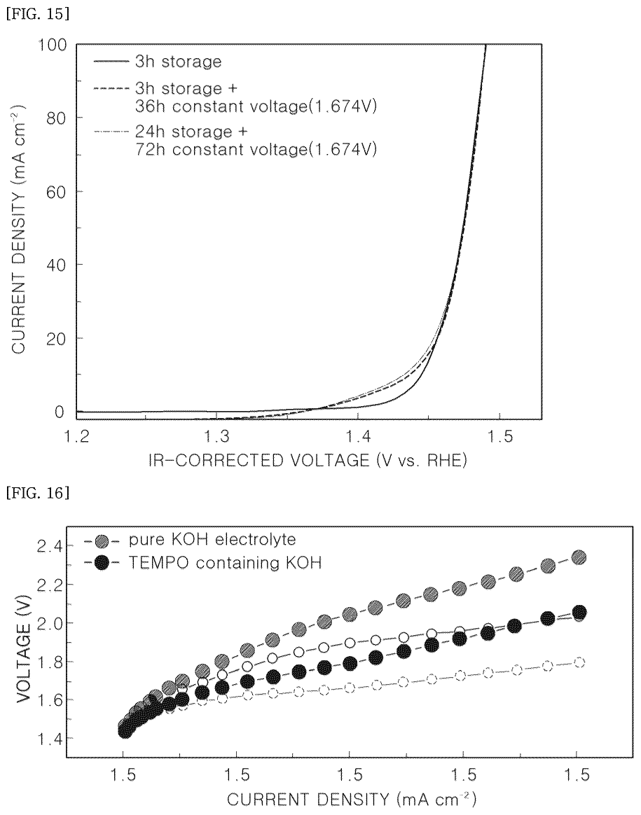

FIG. 15 shows durability characteristics of catalytic promotion ability in intermittent operating conditions.

Specifically, after 1 day of open-circuit storage, overvoltage was maintained at a current density of 100 mA/cm² during 3 days of constant voltage (1.674V vs. RHE) operation.

To verify the practicality of the catalysis promoter, Ni—Fe LDH and Pt/C were applied as the OER catalyst (anode) and the HER catalyst (cathode), respectively, and an anion exchange membrane (FAA-3-50, FuMa-Tech) was used as a separator to prepare a zero-gap component cell (electrode area of 3.23 cm²).

As shown in FIG. 16, a single cell working with the pristine 1 M KOH electrolyte showed cell voltages of 1.75, 2.05, and 2.34 V at current densities of 0.35, 1, and 2 A cm⁻², respectively.

Meanwhile, a single cell working with the TEMPO-containing electrolyte showed cell voltage reductions of about 100 to about 280 mV, with cell voltages of 1.64, 1.79, and 2.06 V at current densities of 0.35, 1, and 2 A/cm², respectively.

Meanwhile, as shown in FIG. 16, voltage efficiency of the single cell working with the pristine 1 M KOH electrolyte and the TEMPO-containing electrolyte was calculated.

Voltage efficiency of a water electrolysis cell using higher heating value (HHV) may be obtained according to Equation 4 below.

$$η ( voltage efficiency ) [ \% ] = Thermoneutral voltage / Cell operating voltage \times 100 \qquad ( 4 )$$

Thermoneutral voltage described in Equation 4 indicates a theoretical voltage required for a water electrolysis reaction considering the latent heat from a liquid state of water to a gas state, which corresponds to 1.48 V.

Accordingly, the voltage efficiency of the single cell working with the pristine 1 M KOH electrolyte may be calculated to be 84.6, 72.2, and 63.2% at current densities of 0.35, 1, and 2 A/cm², respectively.

The TEMPO-containing electrolyte showed a marked increase in the voltage efficiency of the single cell, with 90.2, 82.7, and 71.8% at current densities of 0.35, 1, and 2 A/cm², respectively.

That is words, when TEMPO was used to promote OER in single cell tests voltage efficiency increased by about 10%.

The results indicate that the catalysis promoter has the potential to significantly reduce electricity consumption required for water electrolysis.

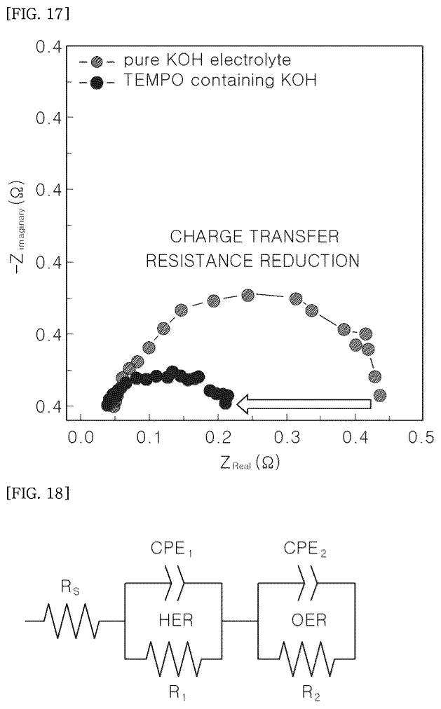

In addition, as shown in FIG. 17, the Nyquist plot obtained at a current density of 50 mA/cm² shows that in the TEMPO-containing KOH electrolyte, the semicircle has a reduced diameter, thereby significantly reducing charge transfer resistance (R_{ct}).

Fitting to electrochemical impedance spectroscopy (EIS) was performed for quantitative comparison of charge transfer resistance reduction.

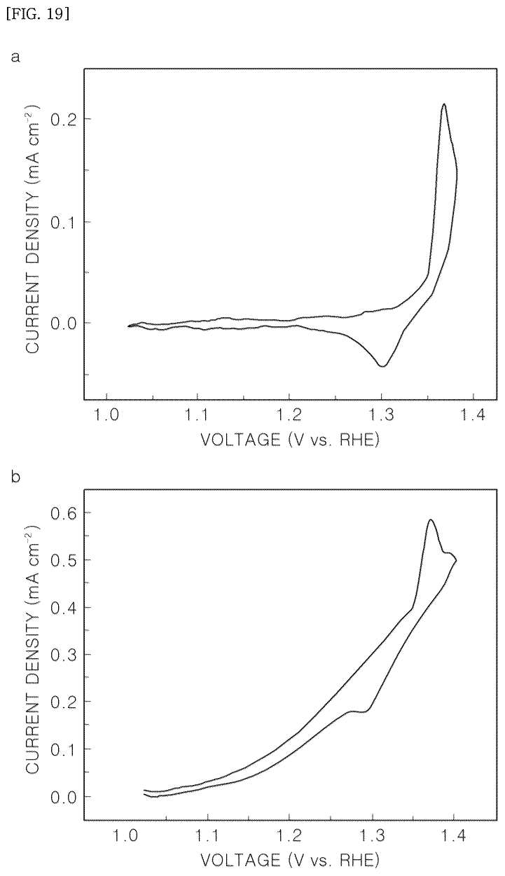

As shown in FIG. 18, an equivalent circuit model of an AEM-based single cell test is set up, and EIS fitting through this equivalent circuit model is performed to quantitatively compare phase elements including charge transfer resistance of an OER (anode) portion and an HER (cathode) portion.

Impedance parameters obtained by fitting EIS experimental data are shown in Table 1 below.

TABLE 1

| | Pristine KOH | TEMP containing |
|---|---|---|
| Parameter[unit] | electrolyte | KOH electrolyte |
| Rₛ [Ω] | 0.04867 | 0.03783 |
| R₁ [Ω] | 0.03096 | 0.03742 |
| Q₁ [F [symbol] s\hat{ }(a-1)] | 7.125 | 8.888 |
| a₁ | 0.497 | 1 |
| R₂ [Ω] | 0.3786 | 0.138 |
| Q₂ [F [symbol] s\hat{ }(a-1)] | 0.1011 | 0.4765 |
| a₂ | 0.8388 | 0.6799 |

[symbol]

indicates data missing or illegible when filed

Rₛ indicates solution resistance, R₁ and R² indicate charge transfer resistance of HER and OER, respectively, and Q and a indicate constant and exponent of constant phase element (CPE), respectively.

A clear difference was observed in Rot on the OER (anode) side.

The R_{ct} of the anode portion in the TEMPO-containing KOH electrolyte was 0.1380Ω, while the R_{ct} of the anode portion in the pristine KOH electrolyte was 0.3786Ω, indicating that R_{ct} decreased by about 3 times after applying TEMPO to the KOH electrolyte.

Meanwhile, the R_{ct} of the cathode portion showed a negligible change compared to the change in Rot of the anode portion.

The results indicate that high selectivity in catalytic promotion for oxygen evolution reaction (OER) by TEMPO is present.

In conclusion, the AEM-based single cell test demonstrated that the catalysis promoter for oxygen evolution reaction (OER) is applicable to commercial water electrolysis devices.

These results clearly show a reduction in overall cell voltage and R_{ct}, and an improvement in voltage efficiency as well.

Other candidates that are usable as catalysis promoters were examined to see whether those candidates had the same effect as TEMPO, and whether the catalysis promoter is applicable to other OER catalysts was also examined.

First, by using TEMPO derivatives containing various functional groups having the same redox activity motif as TEMPO, catalytic promotion ability of a nitroxyl group-based redox motif was demonstrated and also the impact of introducing additional functional groups was investigated.

Chemical tuning to introduce functional groups into the catalysis promoter may affect the redox ability of the catalysis promoter depending on the type of functional group.

Accordingly, 4-hydroxy-TEMPO (HTEMPO), a TEMPO in which a hydroxyl group was added, and 4-oxo-TEMPO (OTEMPO), a TEMPO in which an oxo group was added, were applied as catalysis promoters for OER in alkaline water electrolysis.

The suitability of such TEPMP derivatives was determined in advance as shown in FIGS. 19 to 21.

As shown in FIG. 19, the redox potentials of HTEMPO and OTEMPO are 1.335 V and 1.331 V (vs. RHE), respectively, positioned between the ideal OER potential and the actual OER potential.

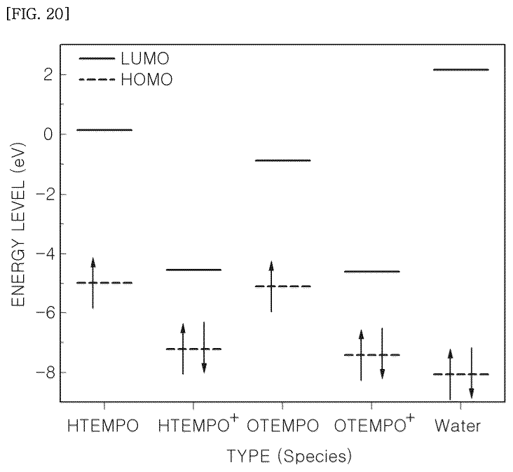

As shown in FIG. 20, the HOMO levels of HTEMPO and OTEMPO in the neutral and oxidized states are positioned below the LUMO level of water solvent molecules, and conversely, the HOMO levels of water solvent molecules are positioned below the LUMO levels of HTEMPO and OTEMPO in the neutral and oxidized states.

This indicates that no chemical side reactions take place between the TEMPO derivative and the water solvent.

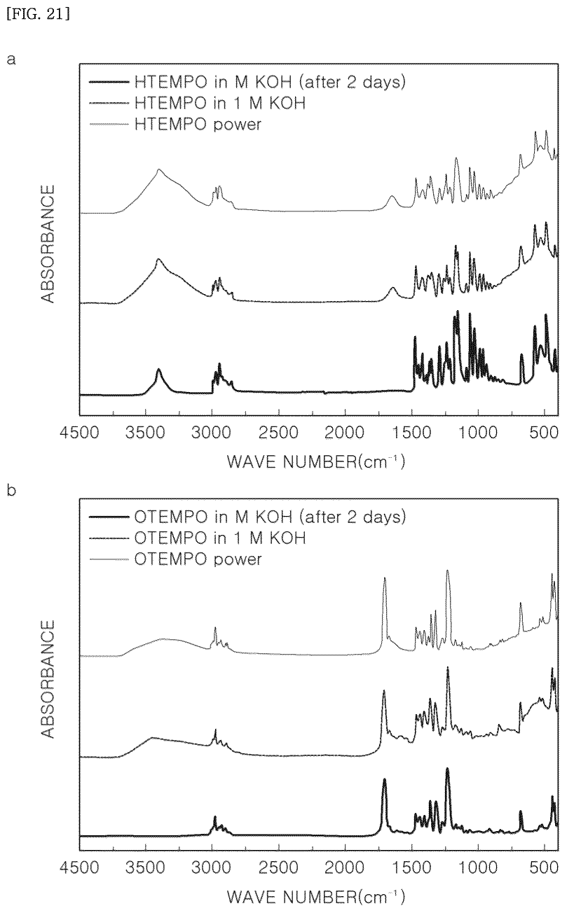

In addition, the ex-situ FTIR spectrum of FIG. 21 shows that the unique characteristic peaks of HTEMPO and OTEMPO are maintained even in alkaline environment, indicating that HTEMPO and OTEMPO stable are chemically in alkaline environment.

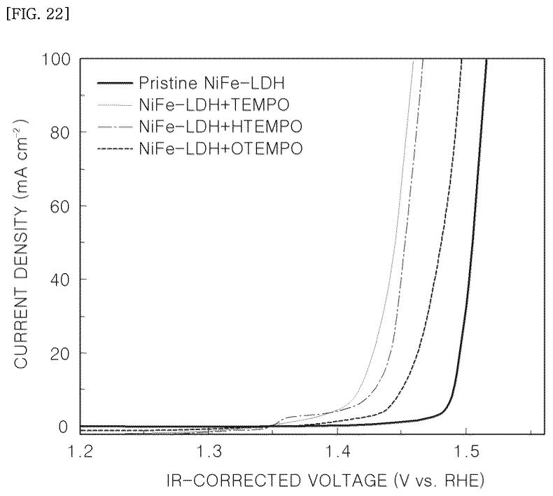

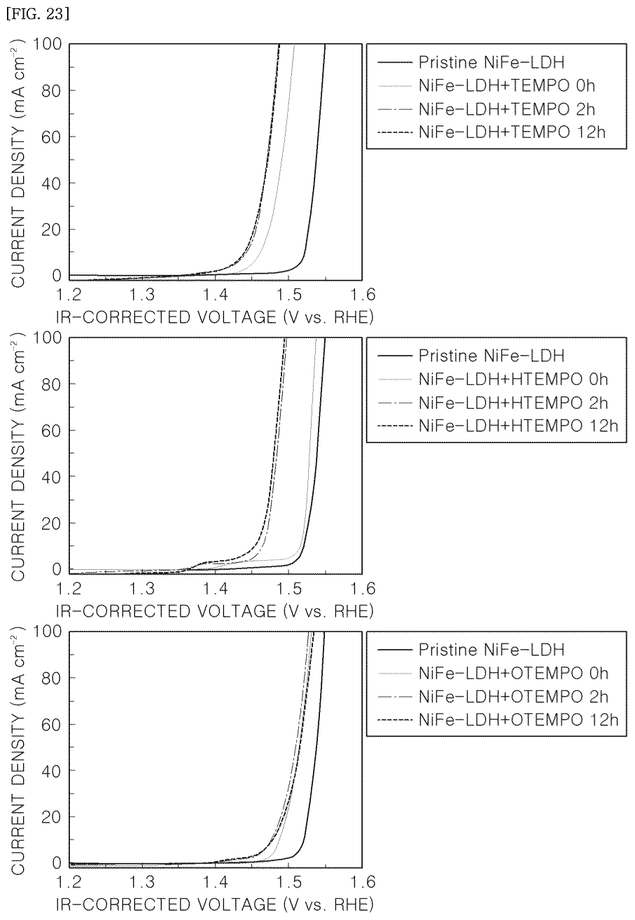

as shown in FIGS. 22 and 23, HTEMPO and OTEMPO successfully demonstrated the ability to promote catalytic activity like TEMPO, which reduced the OER overpotential of NiFe-LDH by 270 mV and 300 mV, respectively, at a current density of 100 mA/cm².

Then, general applicability of the catalysis promoters (TEMPO, HTEMPO, and OTEMPO) to various types of OER catalysts was verified.

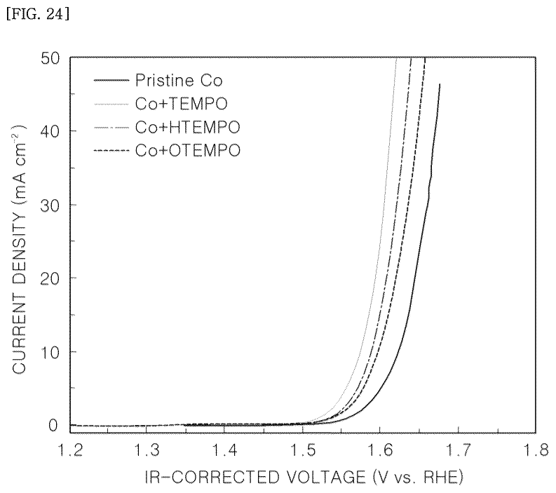

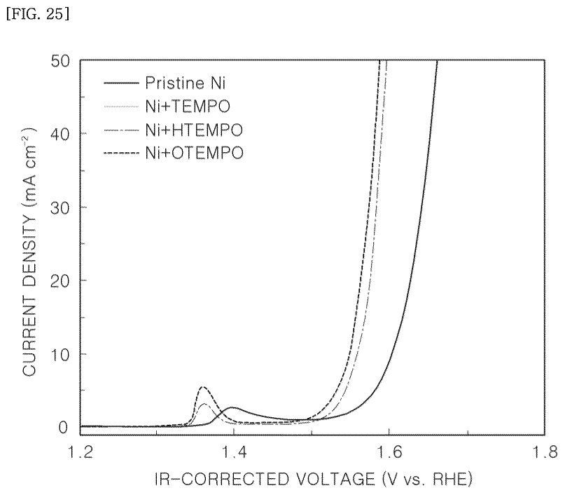

As shown in FIGS. 24 and 25, electrochemical tests were performed on representative OER catalysts of electrodeposited Co and Ni.

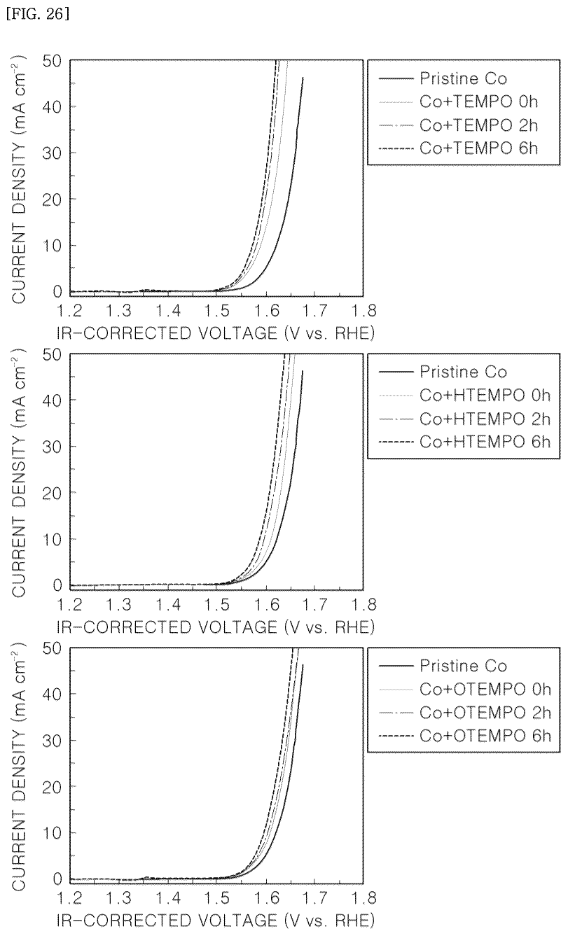

The OER overpotential of the electrodeposited Co catalyst decreased to 370, 390, and 405 mV at a current density of 30 mA/cm² in 1 M KOH electrolyte in which each of 1 mM TEMPO, HTEMPO, and OTEMPO was dissolved, but the Co catalyst without a catalysis promoter had an OER overpotential of 430 mV at a current density of 30 mA/cm² (see FIGS. 24 and 26).

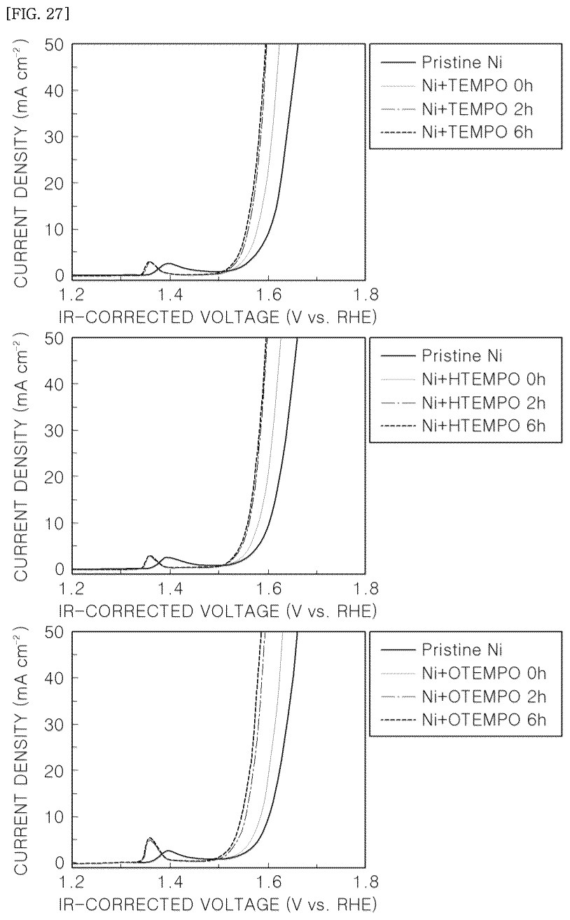

The OER overpotential of the electrodeposited Ni catalyst decreased to 375, 375, and 365 mV at a current density of 50 mA/cm² in 1 M KOH electrolyte in which each of 1 mM TEMPO, HTEMPO, and OTEMPO was dissolved, but the Ni catalyst without a catalysis promoter had an OER overpotential of 430 mV at a current density of 50 mA/cm² (see FIGS. 25 and 27).

In addition, it was observed in FIG. 25 that when the electrodeposited Ni catalyst was used in the OER electrode, the use of catalysis promoter produced an additional effect.

Ni-based oxygen evolution catalysts having Ni active sites are known to have an oxidation peak in which Ni2+ is oxidized to Ni3+ before oxygen evolution.

For the electrodeposited Ni catalysts, the reaction in which Ni2+ is oxidized to Ni3+ is positioned at about 1.4 V VS. RHE, and this may be expressed in Scheme 1 below.

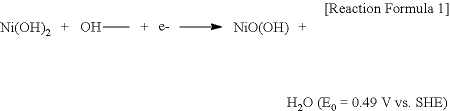

Ni(OH)₂ is spontaneously generated when Ni comes in contact with an alkaline electrolyte.

In this case, the oxidation reaction to produce NiO(OH) from Ni(OH)₂ is known to be a sequential reaction that forms an active phase in the Ni active oxygen evolution catalyst.

As shown in FIG. 25, when TEMPO and TEMPO derivatives are dissolved in an electrolyte, a negative shift of the oxidation peak associated with the formation of the NiO(OH) phase is clearly observed.

The actual and ideal potentials for this oxidation reaction of Ni²⁺ to Ni³⁺ are 1.4 V and 1.316 V (vs. RHE), respectively, and the redox potential of the TEMPO series is about 1.33 to 1.34 V (vs. RHE).

The catalysis promoters (TEMPO, HTEMPO, OTEMPO) of the present invention promote the reaction in which Ni²⁺ is oxidized to Ni³⁺ to form an active NiO(OH) phase, thereby having an effect of further accelerating the oxygen evolution reaction of the electrodeposited Ni catalyst.

Taken together, it is seen that materials having nitroxyl groups may be used as catalysis promoters for OER in alkaline-based water electrolysis devices.

Moreover, the catalyst promotion ability may have a synergistic effect depending on the combination of the OER catalyst used and catalysis promoter molecules.

Quantitative analysis was performed on the basis for the ability to promote catalytic activity of the present invention in terms of electron energy level and on oxygen evolution through the catalysis promoter.

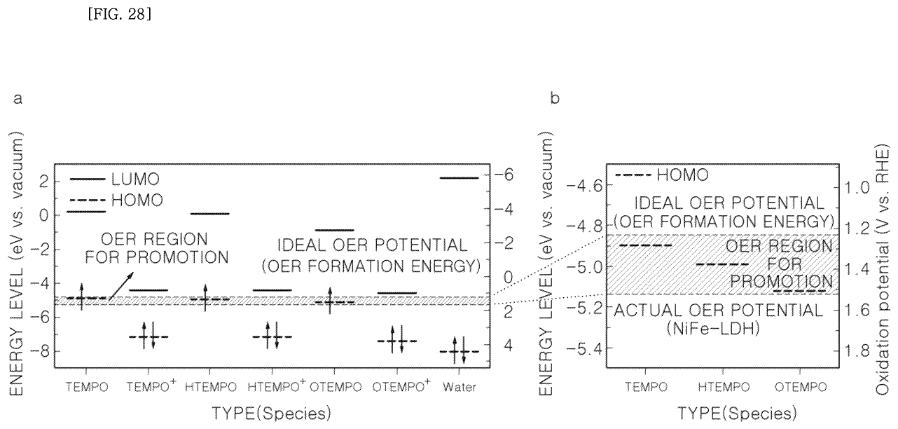

FIG. 28A shows molecular orbital energy levels of EMPO and derivatives thereof in the neutral and oxidized states, molecular orbital energy levels of water solvent molecules in an electrolyte, and the necessity of organic molecules to be utilized as catalysis promoters for OER.

The HOMO energy level of TEMPO and derivatives thereof may be predicted at an electronic level by comparing the ideal OER potential and the actual OER potential.

According to Koopmans' theorem, it may be understood that the HOMO energy level of molecules undergoing an oxidation reaction is correlated with ionization energy.

Referring to FIGS. 28A and 28B, it may be clearly observed that the HOMO energy level of TEMPO and derivatives thereof in the neutral state is positioned between the gray dotted line of the ideal OER potential and the blue dotted line, which is the actual OER potential of the NiFe-LDH OER catalyst.

The lower oxidation potential of the catalysis promoter relative to the OER potential requires less energy to activate the catalysis promoter as the oxidized catalysis promoter, and accordingly, the narrower the gap between the HOMO energy level and the formation energy of OER, the greater are the chances of showing better catalyst promotion ability.

Therefore, it is indicated at the electronic energy level that TEMPO and derivatives thereof have the driving force to serve as a catalysis promoter in an alkali-based water electrolysis device.

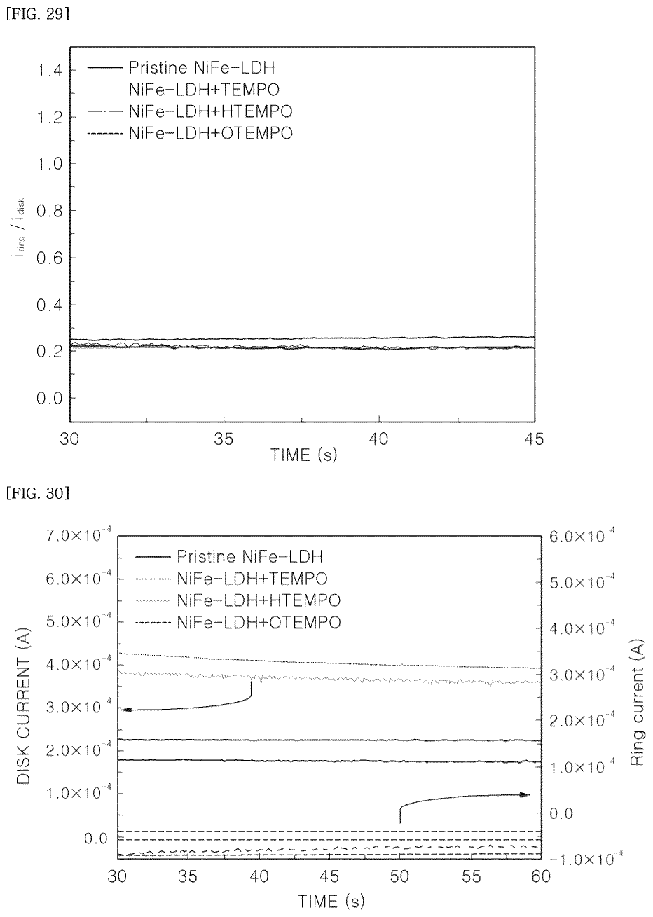

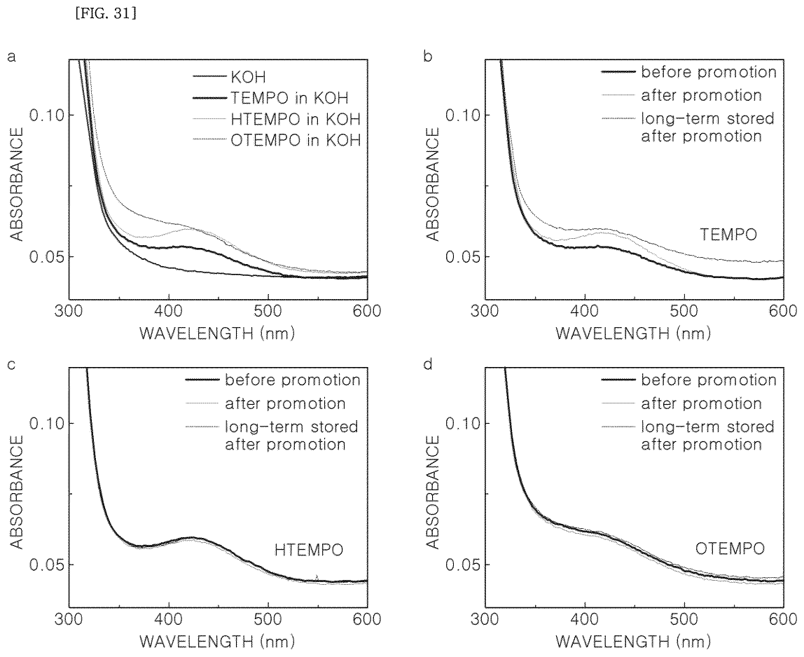

In addition, oxygen evolution efficiency was measured through rotating ring disk electrode (RRDE) analysis and is shown in FIGS. 29 and 30.

The RRDE analysis performed was intended to determine whether oxidation current changes observed in LSV curves of catalyst performance evaluation when a catalysis promoter is applied to a water electrolysis device originates pristinely from OER.

The RRDE analysis allows the observation of two different electrochemical reactions each at a disk electrode and a ring electrode.

Therefore, two different electrochemical conditions were set to induce oxygen evolution reaction (OER) and oxygen reduction reaction (ORR) in the disk (1.43 V vs. RHE) and ring (0.33 V vs. RHE), respectively.

OER is a 4-electron reaction, and ORR may follow a 2-electron transfer mechanism or a 4-electron transfer mechanism as shown below.

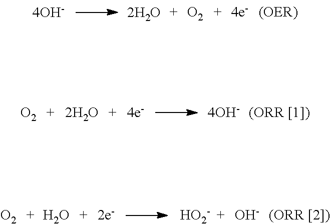

Accordingly, as the ratio of generated and consumed electrons in OER and ORR is already defined by the mechanism described above, the ratio of disk current and ring current will have a specific value between 0.5 and 1.

The ratio of ring current to disk current obtained from pristine OER as a NiFe-LDH model OER catalyst was about 0.22.

Assuming that ring current collection efficiency is 0.38, the obtained current ratio of about 0.22 may be converted to the actual ratio of evolved and consumed electrons of OER and ORR of about 0.58.

However, for quantitative analysis, it was assumed that the ring current collection efficiency was the same in all experiments, and thus only directly obtained current ratios were used.

NiFe-LDH introduction of a catalysis promoter pristinely undergoes OER and the corresponding ORR in the RRDE analysis, and accordingly, the current ratio of about 0.22 may be used as a reference value for the case where the oxidation current change originates pristinely from OER.

In contrast, current ratio values that deviate from about 0.22 may indicate that undesired electrochemical reactions are present in OER or ORR.

To compare the ratio of oxidation currents resulting from oxygen evolution, the disk current was measured when the oxidation reaction occurred at 1.43 V (vs. RHE), which was a sufficient voltage for oxygen evolution, and the ring current was measured when the reduction reaction occurred at 0.33 V (vs. RHE), and the results are shown in FIG. 29.

The NiFe-LDH OER catalyst in pristine 1 M KOH electrolyte showed a ratio of ring current to disk current of about 0.22, and the value serves as a criterion for determining whether additional side reactions are included in the OER promoted by the catalytically active promoter.

The ratio of ring current to disk current in NiFe-LDH electrolytes containing each of TEMPO-, HTEMPO-, and OTEMPO is about 0.22, about 0.22, and about 0.25, respectively.

The ratio of currents obtained in the electrolyte containing TEMPO and HTEMPO is exactly the same as the value obtained in the pristine electrolyte, and the currents are promoted by the TEMPO and HTEMPO catalysts formed only of OER without any additional side reactions.

A slightly higher current ratio is observed in the electrolyte containing OTEMPO, and it is considered that some undesired electrochemical reduction occurred at 0.33 V (vs. RHE).

However, this phenomenon is not a concern since the OER operates through an oxidation reaction and starts above 1.23 V (vs. RHE) and thus the catalytic promotion of OER is not affected.

Referring to FIG. 30, the absolute amount of disk current and ring current increased in the electrolyte containing the catalysis promoter, indicating that more oxygen gas was generated in the same potential conditions.

In addition, referring to FIG. 31, results of measuring ultraviolet-visible (UV-vis) spectra of the electrolytes containing TEMPO and derivatives thereof showed the same results for before promotion, after promotion, and upon long-term storage after promotion, indicating that TEMPO and derivatives thereof were stable.

In the cyclic voltammetry (CV) curves of TEMPO, HTEMPO, and OTEMPO in FIGS. 7 and 19 described above, the very small oxidation current suggests that the oxidation current generated in the electrolyte containing the catalysis promoter originates only from OER.

Materials used in the present invention were prepared as follows.

All chemicals were used without further purification.

TEMPO, HTEMPO (4-hydroxy-TEMPO), OTEMPO (4-Oxo-OTEMPO), and ammonium fluoride (NH4F) were purchased from Sigma-Aldrich (UK), and nickel(II) nitrate hexahydrate (Ni(NO₃)₂·6H₂O), nickel(II) chloride hexahydrate (NiCl₂·6H₂O), nickel(II) sulfate hexahydrate (NiSO₄·6H₂O), HCl solution (20%), and 1 M potassium hydroxide (KOH) aqueous solution were purchased from Daejung Chemical.

Urea (CH₄N₂O) and boric acid (purity: 99.5%) were purchased from Junsei (Japan), and iron (III) nitrate nonahydrate (Fe(NO₃)₃·9H₂O) was purchased from Wako (Japan).

Nickel coins (ATI 201TM, purity: 99.6%) used as a substrate for a catalyst electrode were purchased from ATI Flat Rolled Products (USA).

Carbon substrate supported Pt catalysts (Pt/C, 47 wt % Pt) used for a cathode of a single cell was purchased from Tanaka Kikinzoku Kogyo.

Iron porous substrates (2.0 mm, 2,000 g m-2) used for an anode of a single cell were purchased from Alantum.

Anion exchange membranes (Fumasep FAA-3-50, 50 μm thick) used in single cell experiments were purchased from FuMa-Tech.

1 mM of TEMPO, 1 mM of HTEMPO, and 1 mM of OTEMPO dissolved in 1 M potassium hydroxide solution were used to prepare an electrolyte containing a catalysis promoter (OCP).

To prepare an NiFe-LDH model OER catalyst electrode, NiFe-LDH powder was prepared through hydrothermal synthesis, and the NiFe-LDH powder was deposited on Ni metal coins during the hydrothermal synthesis.

0.05 M of Ni(NO₃)₂·6H₂O, 0.015 M of Fe(NO₃)₃·9H₂O, 0.36 M of CH₄N₂O, and 0.12 M of NH₄F were dissolved in 30 mL of distilled water.

The solution was sonicated for 10 minutes and then stirred for 10 minutes.

Thereafter, the solution was transferred to a Teflon-coated stainless steel reactor, a Ni coin as a substrate was placed in the bottom of the reactor, and then stored at 120° C. for 1 hour.

After cooling at room temperature, the synthesized NiFe-LDH model OER catalyst electrode was washed with distilled water and ethanol several times and dried at 65° C. for 6 hours.

The electrode synthesis method involved electroplating of the electrode, and a potentiostat (SP240, Bio-logic) was used for the process.

0.1 M boric acid as a pH buffer and 0.5 M nickel chloride hexahydrate as a metal ion donor were dissolved in deionized water to prepare a capture solution.

Before capture, the Ni coins were soaked in HCl solution for 5 minutes to remove a surface oxide layer, and then washed with deionized water.

Electrode capture was performed for 10 minutes at −50 mA cm⁻² at room temperature.

After capture, the electrode was washed with deionized water and dried in a vacuum dryer.

Electrochemical properties were measured through the following method.

To analyze the catalytic promotion ability of TEMPO, HTEMPO, and OTEMPO, electrochemical performance was investigated using a three-electrode electrochemical cell and a Bio-logic SP-240 potentiostat.

Pt and Hg/HgO (in 1 M KOH) were used as a counter electrode and a reference electrode, respectively.

The prepared catalyst electrode was accommodated in a custom working electrode holder formed of a PTFE frame and Pt wire to assemble a working electrode.

All electrochemical measurements were performed using 1 M potassium hydroxide solution, and 1 M potassium hydroxide solution containing 1 mM TEMPO, 1 mM HTEMPO, and 1 mM OTEMPO.

The applied potential was converted to RHE using a standard relationship between voltage (vs. Hg/H/HgO) and RHE.

$$( {E}_{RHE} = {E}_{Hg / HgO} + 0.924 V )$$

High-frequency resistance (HFR) was measured through electrochemical impedance spectroscopy (EIS), and the measured potential was corrected to the IR-corrected potential.

RRDE experiments were performed to evaluate oxygen evolution efficiency, 1.43 V VS. RHE was applied to a catalyst-coated disk electrode for evolution reaction, and 0.33 V vs. RHE was applied to a Pt ring of a working electrode for an electrochemical reduction reaction of the evolved oxygen.

A zero-gap single cell (active area: 3.23 cm²) formed of a Pt/C coated carbon gas diffusion layer (GDL) (cathode), NiFe-LDH grown on Fe foam (anode), and FAA-3-50 film (50 μm) was assembled.

On the cathode, a Pt/C catalyst was uniformly applied onto carbon GDL using an ultrasonic spray coater (ND-SP, Nadetek), and Pt loading was 0.2 mg cm⁻². On the anode, an iron porous substrate was immersed in a 0.185 M Ni(SO₄)₂·6H₂O solution at 50° C., and a Ni—Fe LDH layer was grown for 7 hours under pH control in an oxygen atmosphere.

A FAA-3-50 membrane was treated in 1 M KOH solution for 24 hours before single cell operation.

An electrolyte solution was supplied to the single cell only through the anode at a flow rate of 100 ccm to measure single cell performance at 50° C.

Properties of the material were evaluated through the following method.

FTIR spectra were measured in the range from 400 to 4000 cm⁻¹ with a resolution of 4 cm⁻¹ using Spectrum Two (Perkin Elmer, USA).

Ex-situ samples were used to measure the UV-Vis spectra of powder obtained after 15 minutes and 2 days and 1 M KOH electrolyte.

UV-Vis spectra of pristine 1 M KOH electrolyte, and 1 M KOH electrolyte containing 1 mM TEMPO, 1 mM HTEMPO, and 1 mM OTEMPO were measured using a Lambda 1050 (Perkin Elmer, USA) in the range of 300 to 600 nm with a resolution of 10 nm.

The details of the calculation are as follows.

Molecular geometry optimization and energy evaluation for various TEMPO derivatives were performed through density functional theory (DFT) calculations using the Gaussian 09 quantum chemistry package.

All calculations were performed using the Becke-Lee-Yang-Parr (B3LYP) hybrid exchange-correlation functional 56, 57, and 6-31G (d, p) basis set.

In the comparison of HOMO/LUMO energy levels, the correlation between potential (vs. vacuum) and RHE was linked on the basis of reference electrode potential conversion, which will be described below.

Standard hydrogen electrode (SHE) is −4.44 V (vs. vacuum), and reversible hydrogen electrode (RHE) is −0.826 V (vs. SHE) (at pH 14).

Accordingly, RHE is may be converted to 3.614 V (vs. vacuum), the oxidation potential (vs. RHE) is may be obtained by inverting reduction potential (vs. RHE).

As described above, the present invention has proposed a catalysis promoter as a novel means to improve hydrogen evolution efficiency and economic feasibility of an alkali-based water electrolysis device.

The catalysis promoter may promote the behavior of OER catalysts, which may result from spontaneous chemical reduction of a catalysis promoter oxidized by withdrawing electrons from OER intermediates.

The most important design n for a catalysis promoter is to make sure that the catalysis promoter is provided with an appropriate redox potential positioned between an ideal OER potential and an actual OER potential induced by an OER catalyst used.

As described above, TEMPO, a nitroxyl radical compound, was proposed as a catalysis promoter having an appropriate redox potential and chemical stability in alkaline environment.

However, the present invention is not limited thereto, and other materials that the present inventor has not yet discovered but that satisfy the design criteria for the proposed catalysis promoter may also be used as a catalysis promoter.

Catalytic promotion ability showed that OER catalysts of NiFe-LDH, electrodeposited Co, and electrodeposited Ni all showed significantly reduced OER overpotential as shown in Table 2 below, and along with improved exchange current density and long-term robust promotion ability, the commercialization feasibility was also verified through AEM-based single cell experiments.

TABLE 2

| | | Electrodeposited | Electrodeposited |
|---|---|---|---|
| [symbol] | NiFe-LDH [symbol] | Co [symbol] | Ni [symbol] |
| Type of | Overvoltage @ | Overvoltage @ | Overvoltage @ |
| OCP [symbol] | 100 mA cm² [symbol] | 100 mA cm² [symbol] | 100 mA cm² [symbol] |
| Pristine [symbol] | 320 mV [symbol] | 430 mV [symbol] | 430 mV [symbol] |
| TEMPO [symbol] | 256 mV [symbol] | 370 mV [symbol] | 375 mV [symbol] |
| HTEMPL [symbol] | 270 mV [symbol] | 390 mV [symbol] | 375 mV [symbol] |
| OTEMPO [symbol] | 300 mV [symbol] | 405 mV [symbol] | 365 mV [symbol] |

[symbol]

indicates data missing or illegible when filed

Ultimately, the newly proposed electrolyte additive in the present invention may achieve a successful transition from a precious metal-based catalyst to a non-precious metal-based catalyst in the field of water electrolysis devices by inherently improving catalyst efficiency through a catalysis promoter.

Innovative approaches to the introduction of catalysis promoters may present a new direction, initiating a new era of advanced water electrolysis devices towards a carbon-neutral world.

The protection scope of the present invention is not limited to the descriptions and expressions of the embodiments explicitly mentioned above. In addition, it should be noted that the protection scope of the present invention is not limited due to a change or replacement obvious in the art to which the present invention pertains.

1. A catalysis promoter dissolved in an electrolyte of a water electrolysis device using an alkaline electrolyte and promoting the catalytic activity of an oxygen evolution electrode.

2. The catalysis promoter of claim 1, wherein the catalysis promoter is oxidized in a dissolved state in an oxygen evolution reaction of the water electrolysis device and then spontaneously reduced upon meeting an oxygen evolution reaction intermediate product, thereby oxidizing the oxygen evolution reaction intermediate product.

3. The catalysis promoter of claim 1, wherein a redox potential in the alkaline electrolyte is higher than an ideal potential for the oxygen evolution reaction and lower than an actual potential for the oxygen evolution reaction of a catalyst of the oxygen evolution electrode.

4. The catalysis promoter of claim 1, wherein the catalysis promoter is a material having a nitroxyl group-based redox motif.

5. The catalysis promoter of claim 4, wherein the substance having a nitroxyl group-based redox motif is 2,2,6,6-tetramethylpiperidine-1-oxyl (TEMPO).

6. The catalysis promoter of claim 4, wherein the substance having a nitroxyl group-based redox motif is 4-hydroxy-2,2,6,6-tetramethylpiperidine-1-oxyl (HTEMPO).

7. The catalysis promoter of claim 4, wherein the substance having a nitroxyl group-based redox motif is 4-oxo-2,2,6,6-tetramethylpiperidine-1-oxyl (OTEMPO).

8. A water electrolysis device using an alkaline electrolyte, the water electrolysis device comprising a catalysis promoter dissolved in an electrolyte and promoting the catalytic activity of an oxygen evolution electrode.

9. The water electrolysis device of claim 8, wherein the electrolyte is KOH or NaOH.

10. The water electrolysis device of claim 8, wherein the water electrolysis device is an alkaline water electrolysis device or an anion exchange membrane water electrolysis device.

11. The water electrolysis device of claim 8, wherein a catalyst of the oxygen evolution electrode is at least any one selected from the group consisting of NiFe-LDH, electrodeposited Co, and electrodeposited Ni.

12. The water electrolysis device of claim 8, wherein the catalysis promoter is oxidized in a dissolved state in an oxygen evolution reaction of the water electrolysis device and then spontaneously reduced upon meeting an oxygen evolution reaction intermediate product, thereby oxidizing the oxygen evolution intermediate product.

13. The water electrolysis device of claim 8, wherein in the catalysis promoter, a redox potential in the alkaline electrolyte is higher than an ideal potential for the oxygen evolution reaction and lower than an actual potential for the oxygen evolution reaction of a catalyst of the oxygen evolution electrode.

14. The water electrolysis device of claim 8, wherein the catalysis promoter is at least any one selected from the group consisting of 2,6,6-tetramethylpiperidine-1-oxyl (TEMPO), 4-hydroxy-2,2,6,6-tetramethylpiperidine-1-oxyl (HTEMPO), and 4-oxo-2,2,6,6-tetramethylpiperidine-1-oxyl (OTEMPO).

15. The water electrolysis device of claim 8, wherein a catalyst of the oxygen evolution electrode is electrodeposited Ni, and
the catalysis promoter is 4-oxo-2,2,6,6-tetramethylpiperidine-1-oxyl (OTEMPO).
